(19) United States
(12) Patent Application Publication
(10) Pub. No.: US 2009/0072196 A1
(43) Pub. Date: Mar. 19, 2009

(54) RED PHOSPHOR AND METHOD OF PREPARING THE SAME

(75) Inventors: Jae-hee Cho, Yongin-si (KR); Yun-chan Kang, Seoul (KR); Cheol-soo Sone, Anyang-si (KR); Hyung-kun Kim, Suwon-si (KR)

Correspondence Address: BUCHANAN, INGERSOLL & ROONEY PC, POST OFFICE BOX 1404, ALEXANDRIA, VA, 22313-1404, US

(73) Assignees: SAMSUNG ELECTRO-MECHANICS CO., LTD., Suwon-si (KR); KOREA RESEARCH INSTITUTE OF CHEMICAL TECHNOLOGY, Daejeon-si (KR)

(21) Appl. No.: 12/270,171

(22) Filed: Nov. 13, 2008

Related U.S. Application Data
(62) Division of application No. 11/089,479, filed on Mar. 25, 2005.

(30) Foreign Application Priority Data
Aug. 6, 2004 (KR) 10-2004-0061948

(51) Int. Cl. C09K 11/78

(52) U.S. Cl. 252/301.4 R

(57) ABSTRACT

Provided is a red phosphor which is excellent in emission efficiency by a long wavelength UV excitation source and has a fine and uniform particle size. The red phosphor includes a compound represented by (Li.sub.(2−z)−xM.sub.x)(AO.sub.4).sub.y:Eu.sub.z,Sm.sub.q and a flux wherein M is K, Mg, Na, Ca, Sr, or Ba, A is Mo or W, 0.ltoreq.x.ltoreq.2, 0.5.ltoreq.y.ltoreq.5, 0.01.ltoreq.z.ltoreq.1.5, and 0.001.ltoreq.q.ltoreq.1.0. Provided is also a method of preparing the red phosphor.

This application is a divisional of U.S. application Ser. No. 11/089,479, filed on Mar. 25, 2005, which claims priority to Korean Patent Application No. 10-2004-0061948, filed on Aug. 6, 2004, in the Korean Intellectual Property Office, the disclosure of which is incorporated herein in its entirety by reference.

### BACKGROUND OF THE INVENTION

1. Field of the Invention

The present invention relates to a red phosphor and a method of preparing the same.

2. Description of the Related Art

A red phosphor is used as a visible light-emitting material for various lamps or displays such as light emitting diodes (LEDs) and liquid crystal displays (LCDs).

For example, white LEDs have been manufactured by combination of red diodes, green diodes, and blue diodes. Red phosphors are used in the red diodes. However, fabrication of white LEDs including a combination of red diodes, green diodes, and blue diodes is costly. Furthermore, these white LEDs must include a very complicated driving circuit, which increases the sizes of products.

In another types of white LEDs, an ultraviolet (UV) LED is used as an excitation light source and a mixture of a red phosphor, a green phosphor, and a blue phosphor is used as a visible light-emitting material. In these white LEDs, long wavelength UV (e.g. about 410 nm) is mainly used as an excitation light source. In this respect, it is required that the phosphors used in these white LEDs is excellent in visible light-emitting efficiency by the long wavelength UV excitation source.

For these white LEDs, numerous red phosphors, green phosphors, and blue phosphors have been developed. However, the brightness of red phosphors is low, relative to that of green phosphors and blue phosphors. For this reason, in fabrication of white LEDs, red phosphors must be used in an increased amount, relative to green phosphors and blue phosphors.

Examples of red phosphors for long wavelength UV currently known include 3.5MgO0.5MgF.sub.2GeO.sub.2:Mn and K.sub.5Eu(WO.sub.4).sub.6.25 [U.S. Pat. No. 6,589,450, Korean Patent Laid-Open Publication No. 2003-0033864]. However, it is known that these red phosphors have unsatisfactory brightness and very low emission efficiency by an excitation light source of about 400 nm or more.

Generally, the particle size uniformity of red phosphors is not good, relative to that of green phosphors and blue phosphors. Furthermore, the particle size of red phosphors is larger than that of green and blue phosphors. Large or non-uniform particle size of phosphors may cause a serious problem of clogging of a nozzle used for phosphor coating in fabrication of LEDs. Generally, it is preferred that phosphor powders have a uniform particle size of about 20 .mu.m or less.

Phosphors which are excellent in emission efficiency by long wavelength UV are also very important in development of active emission-type LCDs. In the active emission-type LCDs, backlight emitted from a backlight source passes through a liquid crystal layer via a polarizer. The liquid crystal layer allows the backlight to be transmitted or blocked by its orientation so that the backlight forms a predetermined image. The backlight passed through the liquid crystal layer excites a corresponding phosphor to emit light, thereby displaying the image on a front glass. These active emission-type LCDs have advantages of simple structure and easy fabrication, relative to conventional color LCDs. However, since the brightness of red phosphors among used phosphors is low, the active emission-type LCDs have been evaluated as impractical. In particular, long wavelength UV of 393 nm or more in wavelength must be used as a backlight source in the active emission-type LCDs to protect a liquid crystal. The most promising candidate of the backlight source is a UV LED with a wavelength of 390 nm or more. Therefore, development of red phosphors which are excellent in emission efficiency by long wavelength UV is also very important in development of active emission-type LCDs, like in development of red and white LEDs.

### SUMMARY OF THE INVENTION

Embodiments of the present invention provide a red phosphor which is excellent in emission efficiency by a long wavelength UV excitation source and can have a fine and uniform particle size.

The present invention also provides a method of preparing a red phosphor which can have excellent in emission efficiency by a long wavelength UV excitation source and can have a fine and uniform particle size.

The present invention also provides a red light emitting diode (LED) which can be excellent in emission efficiency by a long wavelength UV excitation source.

The present invention also provides a white light emitting diode (LED) which can be excellent in emission efficiency by a long wavelength UV excitation source.

### BRIEF DESCRIPTION OF THE DRAWINGS

The above and other features and advantages of the present invention will become more apparent by describing in detail exemplary embodiments thereof with reference to the attached drawings in which:

FIG. 1 is a scanning electron microscopic (SEM) image of a red phosphor prepared in an example of the present invention;

FIG. 2 is a SEM image of a red phosphor prepared in a comparative example;

FIG. 3 is an analysis result for efficient excitation source determination for red phosphors prepared in examples of the present invention;

FIG. 4 is an analysis result for main emission light wavelength determination for red phosphors prepared in examples of the present invention; and

FIG. 5 is a graph that illustrates a change in emission intensity of a red phosphor with respect to an addition amount of a flux.

### DETAILED DESCRIPTION OF THE INVENTION

The present invention provides a red phosphor including a compound represented by (Li.sub.(2−z)−xM.sub.x)(AO.sub.4).sub.y:Eu.sub.z,Sm.sub.q and a flux, wherein M is K, Mg, Na, Ca, Sr, or Ba, A is Mo or W, 0.ltoreq.x.ltoreq.2, 0.5.ltoreq.y.ltoreq.5, 0.01.ltoreq.z.ltoreq.1.5, and 0.001.ltoreq.q.ltoreq.1.0.

A red phosphor according to an embodiment of the present invention includes a compound of formula 1 below and a flux:

(Li.sub.(2−z))(AO.sub.4).sub.y:Eu.sub.z,Sm.sub.q [Formula 1]

wherein A is Mo or W, 0.5.ltoreq.y.ltoreq.5, 0.01.ltoreq.z.ltoreq.1.5, and 0.001.ltoreq.q.ltoreq.1.0.

A red phosphor according to another embodiment of the present invention includes a compound of formula 2 below and a flux:

(Li.sub.(2-z)−xM.sub.x)(AO.sub.4).sub.y:Eu.sub.z,Sm.sub.q [Formula 2]

wherein M is K, Mg, Na, Ca, Sr, or Ba, A is Mo or W, x+z<2, 0<x.ltoreq.2, 0.5.ltoreq.y.ltoreq.5, 0.01.ltoreq.z.ltoreq.1.5, and 0.001.ltoreq.q.ltoreq.1.0.

A red phosphor according to still another embodiment of the present invention include a compound of formula 3 below and a flux:

(M.sub.x)(AO.sub.4).sub.y:Eu.sub.z,Sm.sub.q [Formula 3]

wherein M is K, Mg, Na, Ca, Sr, or Ba, A is Mo or W, 0<x.ltoreq.2, 0.5.ltoreq.y.ltoreq.5, 0.01.ltoreq.z.ltoreq.1.5, and 0.001.ltoreq.q.ltoreq.1.0.

A method of preparing a red phosphor according to an embodiment of the present invention includes:

dispersing a lithium-containing compound, an A-containing compound, an europium-containing compound, a samarium-containing compound, and a flux in a volatile polar solvent to obtain a slurry; and

thermally heating the slurry at about 600 to about 1,400.degree. C.,

wherein A is Mo or W.

A method of preparing a red phosphor according to another embodiment of the present invention includes:

dispersing a lithium-containing compound, an M-containing compound, an A-containing compound, an europium-containing compound, a samarium-containing compound, and a flux in a volatile polar solvent to obtain a slurry; and

thermally treating the slurry at about 600 to about 1,400.degree. C.,

wherein M is K, Mg, Na, Ca, Sr, or Ba, and A is Mo or W.

A method of preparing a red phosphor according to still another embodiment of the present invention includes:

dispersing an M-containing compound, an A-containing compound, an europium-containing compound, a samarium-containing compound, and a flux in a volatile polar solvent to obtain a slurry; and

thermally treating the slurry at about 600 to about 1,400.degree. C.,

wherein M is K, Mg, Na, Ca, Sr, or Ba, and A is Mo or W.

Embodiments of the present invention also provides a red light emitting diode (LED) comprising the red phosphor as described above; and a 380-420 nm UV LED.

Embodiments of the present invention also provides a white light emitting diode (LED) comprising a phosphor combination of the red phosphor as described above, a green phosphor and a blue phosphor; and a 380-420 nm UV LED.

Hereinafter, a red phosphor including a compound of formula 1 below and a flux according to an embodiment of the present invention will be described in detail:

(Li.sub.(2-z))(AO.sub.4).sub.y:Eu.sub.z,Sm.sub.q [Formula 1]

wherein A is Mo or W, 0.5.ltoreq.y.ltoreq.5, 0.01.ltoreq.z.ltoreq.1.5, and 0.001.ltoreq.q.ltoreq.1.0.

In the red phosphor of this embodiment, the compound of formula 1 and the flux coexist. The compound of formula 1 serves to efficiently emit red light after being excited by long wavelength UV. The flux allows the compound of formula 1 to have a uniform particle size during preparation of the red phosphor. The flux remains in the red phosphor of embodiments of the present invention after the preparation. In this respect, the flux in the red phosphor of embodiments of the present invention can also serve as an indicator representing that the red phosphor of embodiments of the present invention includes the compound of formula 1 with a uniform particle size.

If the content of the flux in the red phosphor of this embodiment is too high, emission intensity may decrease. On the other hand, if it is too low, enhancement of phosphor particle size uniformity may be insignificant. Typically, the content of the flux in the red phosphor of this embodiment may range from about 0.001 to about 20 wt %. Preferably, the content of the flux in the red phosphor of this embodiment may range from about 10 to about 15 wt %.

The flux may be a boron-containing compound. Examples of the boron-containing compound include B.sub.2O.sub.3 and H.sub.3BO.sub.3.

In the red phosphor of this embodiment, the compound of formula 1 is present in the form of powders with a fine and uniform particle size. The flux is contained in the powders. The powders composed of the compound of formula 1 may have a particle size of about 3 to about 20 .mu.m. Such a fine and uniform particle size can be accomplished by the presence of the flux.

In the compound of formula 1, A may be Mo or W. In the compound of formula 1, a lithium molybdenum moiety or a lithium tungsten moiety serves as a matrix, an europium moiety serves as an activator creating a red energy level, and a samarium oxide moiety serves as an expedient. The compound of formula 1 is efficiently excited by long wavelength UV of about 400 nm in wavelength and emits strong red visible light.

Therefore, the red phosphor of this embodiment can efficiently emit red visible light with enhanced brightness and have a fine and uniform particle size.

Hereinafter, a red phosphor including a compound of formula 2 below and a flux according to another embodiment of the present invention will be described in detail:

(Li.sub.(2−z)−xM.sub.x)(AO.sub.4).sub.y:Eu.sub.z,Sm.sub.q [Formula 2]

wherein M is K, Mg, Na, Ca, Sr, or Ba, A is Mo or W, x+z<2, 0<x.ltoreq.2 (preferably, 0.5<x.ltoreq.2), 0.5.ltoreq.y.ltoreq.5, 0.01.ltoreq.z.ltoreq.1.5, and 0.001.ltoreq.q.ltoreq.1.0.

In the red phosphor of this embodiment, the compound of formula 2 and the flux coexist. The compound of formula 2 serves to efficiently emit red light after being excited by long wavelength UV. The flux allows the compound of formula 2 to have a uniform particle size during preparation of the red phosphor. The flux remains in the red phosphor of embodiments of the present invention after the preparation. In this respect, the flux in the red phosphor of embodiments of the present invention can also serve as an indicator representing that the red phosphor of embodiments of the present invention includes the compound of formula 2 with a uniform particle size.

If the content of the flux in the red phosphor of this embodiment is too high, emission intensity may decrease. On the other hand, if it is too low, enhancement of phosphor particle size uniformity may be insignificant. Typically, the content of the flux in the red phosphor of this embodiment may range from about 0.001 to about 20 wt %. Preferably, the content of the flux in the red phosphor of this embodiment may range from about 10 to about 15 wt %.

The flux may be a boron-containing compound. Examples of the boron-containing compound include B.sub.2O.sub.3 and H.sub.3BO.sub.3.

In the red phosphor of this embodiment, the compound of formula 2 is present in the form of powders with a fine and uniform particle size. The flux is contained in the powders. The powders composed of the compound of formula 2 may have a particle size of about 3 to about 20 .mu.m. Such a fine and uniform particle size can be accomplished by the presence of the flux.

In the compound of formula 2, A may be Mo or W. In the compound of formula 2, a lithium molybdenum moiety or a lithium tungsten moiety serves as a matrix, an europium moiety serves as an activator creating a red energy level, and a samarium oxide moiety serves as an expedient. In the compound of formula 2, M is K, Mg, Na, Ca, Sr, or Ba. The presence of these metal components changes the composition of the matrix, which may change emission characteristics of the compound of formula 2. However, in all cases, the red phosphor of this embodiment can be efficiently excited by long wavelength UV and emit strong red visible light.

Therefore, the red phosphor of this embodiment can efficiently emit red visible light with enhanced brightness and have a fine and uniform particle size.

Hereinafter, a red phosphor including a compound of formula 3 below and a flux according to still another embodiment of the present invention will be described in detail:

(M.sub.x)(AO.sub.4).sub.y:Eu.sub.z,Sm.sub.q [Formula 3]

wherein M is K, Mg, Na, Ca, Sr, or Ba, A is Mo or W, 0<x.ltoreq.2 (preferably 0.5<x.ltoreq.2), 0.5.ltoreq.y.ltoreq.5, 0.01.ltoreq.z.ltoreq.1.5, and 0.001.ltoreq.q.ltoreq.1.0.

In the red phosphor of this embodiment, the compound of formula 3 and the flux coexist. The compound of formula 3 serves to efficiently emit red light after being excited by long wavelength UV. The flux allows the compound of formula 3 to have a uniform particle size during preparation of the red phosphor. The flux remains in the red phosphor of embodiments of the present invention after the preparation. In this respect, the flux in the red phosphor of embodiments of the present invention can also serve as an indicator representing that the red phosphor of embodiments of the present invention includes the compound of formula 3 with a uniform particle size.

If the content of the flux in the red phosphor of this embodiment is too high, emission intensity may decrease. On the other hand, if it is too low, enhancement of phosphor particle size uniformity may be insignificant. Typically, the content of the flux in the red phosphor of this embodiment may range from about 0.001 to about 20 wt %. Preferably, the content of the flux in the red phosphor of this embodiment may range from about 10 to about 15 wt %.

The flux may be a boron-containing compound. Examples of the boron-containing compound include B.sub.2O.sub.3 and H.sub.3BO.sub.3.

In the red phosphor of this embodiment, the compound of formula 3 is present in the form of powders with a fine and uniform particle size. The flux is contained in the powders. The powders composed of the compound of formula 3 may have a particle size of about 3 to about 20 .mu.m. Such a fine and uniform particle size can be accomplished by the presence of the flux.

In the compound of formula 3, A may be Mo or W. In the compound of formula 3, an M-molybdenum moiety or a M-tungsten moiety serves as a matrix, an europium moiety serves as an activator creating a red energy level, and a samarium oxide moiety serves as an expedient. In the compound of formula 3, M is K, Mg, Na, Ca, Sr, or Ba. The presence of these metal components changes the composition of the matrix, which may change emission characteristics of the compound of formula 3. However, in all cases, the red phosphor of this embodiment can be efficiently excited by long wavelength UV and emit strong red visible light.

Therefore, the red phosphor of this embodiment can efficiently emit red visible light with enhanced brightness and have a fine and uniform particle size.

A red phosphor of embodiments of the present invention may be prepared by a solid phase method, a liquid phase method, or a vapor phase method.

Hereinafter, a method of preparing a red phosphor by a solid phase method according to an embodiment of the present invention will be described in detail.

A method of preparing a red phosphor by a solid phase method according to an embodiment of the present invention includes:

dispersing a lithium-containing compound, an A-containing compound, an europium-containing compound, a samarium-containing compound, and a flux in a volatile polar solvent to obtain a slurry; and

thermally heating the slurry at about 600 to about 1,400.quadrature.,

wherein A is Mo or W.

Examples of the lithium-containing compound include lithium-containing oxide, lithium-containing carbonate, lithium-containing chloride, lithium-containing hydroxide, lithium-containing sulfate, lithium-containing fluoride, lithium-containing nitrate, lithium-containing acetate, and a mixture thereof. A more exemplary example of the lithium-containing compound is Li.sub.2CO.sub.3.

As the A-containing compound, there may be used an Mo-containing compound, a W-containing compound, an Mo—W-containing compound, or a mixture thereof. Examples of the Mo-containing compound include Mo-containing oxide, Mo-containing carbonate, Mo-containing chloride, Mo-containing hydroxide, Mo-containing sulfate, Mo-containing fluoride, Mo-containing nitrate, Mo-containing acetate, and a mixture thereof. A more exemplary example of the Mo-containing compound is MoO.sub.3. Examples of the W-containing compound include W-containing oxide, W-containing carbonate, W-containing chloride, W-containing hydroxide, W-containing sulfate, W-containing fluoride, W-containing nitrate, W-containing acetate, and a mixture thereof. A more exemplary example of the W-containing compound is WO.sub.3.

Examples of the europium-containing compound include europium-containing oxide, europium-containing carbonate, europium-containing chloride, europium-containing hydroxide, europium-containing sulfate, europium-containing fluoride, europium-containing nitrate, europium-containing acetate, and a mixture thereof. A more exemplary example of the europium-containing compound is Eu.sub.2O.sub.3.

Examples of the samarium-containing compound include samarium-containing oxide, samarium-containing carbonate, samarium-containing chloride, samarium-containing hydroxide, samarium-containing sulfate, samarium-containing fluoride, samarium-containing nitrate, samarium-containing acetate, and a mixture thereof. A more exemplary example of the samarium-containing compound is Sm.sub.2O.sub.3.

The flux may be a boron-containing compound. Illustrative examples of the flux include B.sub.2O.sub.3, H.sub.3BO.sub.3, and a mixture thereof.

The volatile polar solvent may be acetone.

In the method of this embodiment, first, the slurry is obtained by dispersing the lithium-containing compound, the A-containing compound, the europium-containing compound, the samarium-containing compound, and the flux in the volatile polar solvent.

Relative contents of the lithium-containing compound, the A-containing compound, the europium-containing compound, and the samarium-containing compound in the slurry can be determined according to the composition ratio of the compound of formula 1 to be obtained.

The slurry thus obtained is thermally treated. In the operation of thermally treating the slurry, the volatile polar solvent is removed from the slurry, and the lithium-containing compound, the A-containing compound, the europium-containing compound, and the samarium-containing compound are converted to the compound of formula 1. The compound of formula 1 thus produced is of a particle shape. The flux allows the compound of formula 1 of a particle shape to have a fine and uniform particle size. By the presence of the flux, the compound of formula 1 may have a uniform particles size of about 20 .mu.m or less. As used herein, the expression “uniform particles size of about 20 .mu.m or less” indicates that large particles of more than about 20 .mu.m in size are not substantially produced.

The red phosphor prepared by the method of this embodiment includes the compound of formula 1 with a fine and uniform particle size and the flux. Even when the flux remains in the red phosphor thus prepared, the emission characteristics of the red phosphor are not adversely affected.

If a temperature for thermally treating the slurry is too low, the compound of formula 1 may not easily be crystallized. On the other hand, if it is too high, the compound of formula 1 may be molten, thereby lowering emission intensity. Furthermore, a produced red phosphor may have unwanted physical properties. In this regard, it is preferable that the temperature for thermally treating the slurry ranges from about 600 to about 1,400.degree. C.

The operation of thermally treating the slurry may be performed under an oxidizing atmosphere or a reducing atmosphere according to properties of raw materials.

Preferably, the operation of thermally treating the slurry is performed for 1 to 10 hours. If the thermal treatment duration is less than one hour, sufficient crystals may not be obtained. On the other hand, if it exceeds 10 hours, coarse powders may be produced, thereby decreasing emission intensity.

The method of this embodiment may further include washing. The washing is to remove the flux from the red phosphor including the compound of formula 1 and the flux. In the operation of washing, a cleaning solution capable of dissolving the flux is used. The cleaning solution may be water. By the washing, the content of the flux in the red phosphor can be decreased. Since the emission characteristics of the red phosphor of the present invention are determined by the compound of formula 1, even when the flux is removed from the red phosphor, the emission characteristics of the red phosphor are not adversely affected.

The method of this embodiment may further include removing the volatile polar solvent from the slurry prior to the operation of thermally treating the slurry. For this, the slurry may be dried at about 40 to about 150.quadrature.

A method of preparing a red phosphor according to another embodiment of the present invention includes:

dispersing a lithium-containing compound, an M-containing compound, an A-containing compound, an europium-containing compound, a samarium-containing compound, and a flux in a volatile polar solvent to obtain a slurry; and

thermally treating the slurry at about 600 to about 1,400.degree. C. At this time, M is one or more selected from K, Mg, Na, Ca, Sr, and Ba, and A is Mo or W.

Examples of the lithium-containing compound include lithium-containing oxide, lithium-containing carbonate, lithium-containing chloride, lithium-containing hydroxide, lithium-containing sulfate, lithium-containing fluoride, lithium-containing nitrate, lithium-containing acetate, and a mixture thereof. A more exemplary example of the lithium-containing compound is Li.sub.2CO.sub.3.

As the M-containing compound, there may be a K-containing compound, an Mg-containing compound, a Na-containing compound, a Ca-containing compound, a Sr-containing compound, a Ba-containing compound, a compound containing two or more selected from K, Mg, Na, Ca, Sr, and Ba, or a mixture thereof. Examples of the K-containing compound include K-containing oxide, K-containing carbonate, K-containing chloride, K-containing hydroxide, K-containing sulfate, K-containing fluoride, K-containing nitrate, K-containing acetate, and a mixture thereof. Examples of the Mg-containing compound include Mg-containing oxide, Mg-containing carbonate, Mg-containing chloride, Mg-containing hydroxide, Mg-containing sulfate, Mg-containing fluoride, Mg-containing nitrate, Mg-containing acetate, and a mixture thereof. Examples of the Na-containing compound include Na-containing oxide, Na-containing carbonate, Na-containing chloride, Na-containing hydroxide, Na-containing sulfate, Na-containing fluoride, Na-containing nitrate, Na-containing acetate, and a mixture thereof. Examples of the Ca-containing compound include Ca-containing oxide, Ca-containing carbonate, Ca-containing chloride, Ca-containing hydroxide, Ca-containing sulfate, Ca-containing fluoride, Ca-containing nitrate, Ca-containing acetate, and a mixture thereof. Examples of the Sr-containing compound include Sr-containing oxide, Sr-containing carbonate, Sr-containing chloride, Sr-containing hydroxide, Sr-containing sulfate, Sr-containing fluoride, Sr-containing nitrate, Sr-containing acetate, and a mixture thereof. Examples of the Ba-containing compound include Ba-containing oxide, Ba-containing carbonate, Ba-containing chloride, Ba-containing hydroxide, Ba-containing sulfate, Ba-containing fluoride, Ba-containing nitrate, Ba-containing acetate, and a mixture thereof. As the A-containing compound, there may be used an Mo-containing compound, a W-containing compound, an Mo—W-containing compound, or a mixture thereof. Examples of the Mo-containing compound include Mo-containing oxide, Mo-containing carbonate, Mo-containing chloride, Mo-containing hydroxide, Mo-containing sulfate, Mo-containing fluoride, Mo-containing nitrate, Mo-containing acetate, and a mixture thereof. A more exemplary example of the Mo-containing compound is MoO.sub.3. Examples of the W-containing compound include W-containing oxide, W-containing carbonate, W-containing chloride, W-containing hydroxide, W-containing sulfate, W-containing fluoride, W-containing nitrate, W-containing acetate, and a mixture thereof. A more exemplary example of the W-containing compound is WO.sub.3.

Examples of the europium-containing compound include europium-containing oxide, europium-containing carbonate, europium-containing chloride, europium-containing hydroxide, europium-containing sulfate, europium-containing fluoride, europium-containing nitrate, europium-containing acetate, and a mixture thereof. A more exemplary example of the europium-containing compound is Eu.sub.2O.sub.3.

Examples of the samarium-containing compound include samarium-containing oxide, samarium-containing carbonate, samarium-containing chloride, samarium-containing hydroxide, samarium-containing sulfate, samarium-containing fluoride, samarium-containing nitrate, samarium-containing acetate, and a mixture thereof. A more exemplary example of the samarium-containing compound is Sm.sub.2O.sub.3.

The flux may be a boron-containing compound. Illustrative examples of the flux include B.sub.2O.sub.3, H.sub.3BO.sub.3, and a mixture thereof.

The volatile polar solvent may be acetone.

In the method of this embodiment, first, the slurry is obtained by dispersing the lithium-containing compound, the M-containing compound, the A-containing compound, the europium-containing compound, the samarium-containing compound, and the flux in the volatile polar solvent.

Relative contents of the lithium-containing compound, the M-containing compound, the A-containing compound, the europium-containing compound, and the samarium-containing compound in the slurry can be determined according to the composition ratio of the compound of formula 2 to be obtained.

The slurry thus obtained is thermally treated. In the operation of thermally treating the slurry, the volatile polar solvent is removed from the slurry, and the lithium-containing compound, the M-containing compound, the A-containing compound, the europium-containing compound, and the samarium-containing compound are converted to the compound of formula 2. The compound of formula 2 thus produced is of a particle shape. The flux allows the compound of formula 2 of a particle shape to have a fine and uniform particle size. By the presence of the flux, the compound of formula 2 may have a uniform particles size of about 20 .mu.m or less. As used herein, the expression “uniform particles size of about 20 .mu.m or less” indicates that large particles of more than about 20 .mu.m in size are not substantially produced.

The red phosphor prepared by the method of this embodiment includes the compound of formula 2 with a fine and uniform particle size and the flux. Even when the flux remains in the red phosphor thus prepared, the emission characteristics of the red phosphor are not adversely affected.

If a temperature for thermally treating the slurry is too low, the compound of formula 2 may not easily be crystallized. On the other hand, if it is too high, the compound of formula 2 may be molten, thereby lowering emission intensity. Furthermore, a produced red phosphor may have unwanted physical properties. In this regard, it is preferable that the temperature for thermally treating the slurry ranges from about 600 to about 1,400.degree. C.

The operation of thermally treating the slurry may be performed under an oxidizing atmosphere or a reducing atmosphere according to properties of raw materials. Preferably, the operation of thermally treating the slurry is performed for 1 to 10 hours. If the thermal treatment duration is less than one hour, sufficient crystals may not be obtained. On the other hand, if it exceeds 10 hours, coarse powders may be produced, thereby decreasing emission intensity.

The method of this embodiment may further include washing. The washing is to remove the flux from the red phosphor including the compound of formula 2 and the flux. In the operation of washing, a cleaning solution capable of dissolving the flux is used. The cleaning solution may be water. By the washing, the content of the flux in the red phosphor can be decreased. Since the emission characteristics of the red phosphor of the present invention are determined by the compound of formula 2, even when the flux is removed from the red phosphor, the emission characteristics of the red phosphor are not adversely affected.

The method of this embodiment may further include removing the volatile polar solvent from the slurry prior to the operation of thermally treating the slurry. For this, the slurry may be dried at about 40 to about 150.degree. C.

A method of preparing a red phosphor according to still another embodiment of the present invention includes:

dispersing an M-containing compound, an A-containing compound, an europium-containing compound, a samarium-containing compound, and a flux in a volatile polar solvent to obtain a slurry; and

thermally treating the slurry at about 600 to about 1,400.degree. C., wherein M is K, Mg, Na, Ca, Sr, or Ba, and A is Mo or W.

As the M-containing compound, there may be a K-containing compound, an Mg-containing compound, a Na-containing compound, a Ca-containing compound, a Sr-containing compound, a Ba-containing compound, a compound containing two or more selected from K, Mg, Na, Ca, Sr, and Ba, or a mixture thereof. Examples of the K-containing compound include K-containing oxide, K-containing carbonate, K-containing chloride, K-containing hydroxide, K-containing sulfate, K-containing fluoride, K-containing nitrate, K-containing acetate, and a mixture thereof. Examples of the Mg-containing compound include Mg-containing oxide, Mg-containing carbonate, Mg-containing chloride, Mg-containing hydroxide, Mg-containing sulfate, Mg-containing fluoride, Mg-containing nitrate, Mg-containing acetate, and a mixture thereof. Examples of the Na-containing compound include Na-containing oxide, Na-containing carbonate, Na-containing chloride, Na-containing hydroxide, Na-containing sulfate, Na-containing fluoride, Na-containing nitrate, Na-containing acetate, and a mixture thereof. Examples of the Ca-containing compound include Ca-containing oxide, Ca-containing carbonate, Ca-containing chloride, Ca-containing hydroxide, Ca-containing sulfate, Ca-containing fluoride, Ca-containing nitrate, Ca-containing acetate, and a mixture thereof. Examples of the Sr-containing compound include Sr-containing oxide, Sr-containing carbonate, Sr-containing chloride, Sr-containing hydroxide, Sr-containing sulfate, Sr-containing fluoride, Sr-containing nitrate, Sr-containing acetate, and a mixture thereof. Examples of the Ba-containing compound include Ba-containing oxide, Ba-containing carbonate, Ba-containing chloride, Ba-containing hydroxide, Ba-containing sulfate, Ba-containing fluoride, Ba-containing nitrate, Ba-containing acetate, and a mixture thereof.

As the A-containing compound, there may be used an Mo-containing compound, a W-containing compound, an Mo—W-containing compound, or a mixture thereof. Examples of the Mo-containing compound include Mo-containing oxide, Mo-containing carbonate, Mo-containing chloride, Mo-containing hydroxide, Mo-containing sulfate, Mo-containing fluoride, Mo-containing nitrate, Mo-containing acetate, and a mixture thereof. A more exemplary example of the Mo-containing compound is MoO.sub.3. Examples of the W-containing compound include W-containing oxide, W-containing carbonate, W-containing chloride, W-containing hydroxide, W-containing sulfate, W-containing fluoride, W-containing nitrate, W-containing acetate, and a mixture thereof. A more exemplary example of the W-containing compound is WO.sub.3.

Examples of the europium-containing compound include europium-containing oxide, europium-containing carbonate, europium-containing chloride, europium-containing hydroxide, europium-containing sulfate, europium-containing fluoride, europium-containing nitrate, europium-containing acetate, and a mixture thereof. A more exemplary example of the europium-containing compound is Eu.sub.2O.sub.3.

Examples of the samarium-containing compound include samarium-containing oxide, samarium-containing carbonate, samarium-containing chloride, samarium-containing hydroxide, samarium-containing sulfate, samarium-containing fluoride, samarium-containing nitrate, samarium-containing acetate, and a mixture thereof. A more exemplary example of the samarium-containing compound is Sm.sub.2O.sub.3.

The flux may be a boron-containing compound. Illustrative examples of the flux include B.sub.2O.sub.3, H.sub.3BO.sub.3, and a mixture thereof.

The volatile polar solvent may be acetone.

In the method of this embodiment, first, the slurry is obtained by dispersing the M-containing compound, the A-containing compound, the europium-containing compound, the samarium-containing compound, and the flux in the volatile polar solvent.

Relative contents of the M-containing compound, the A-containing compound, the europium-containing compound, and the samarium-containing compound in the slurry can be determined according to the composition ratio of the compound of formula 3 to be obtained.

The slurry thus obtained is thermally treated. In the operation of thermally treating the slurry, the volatile polar solvent is removed from the slurry, and the M-containing compound, the A-containing compound, the europium-containing compound, and the samarium-containing compound are converted to the compound of formula 3. The compound of formula 3 thus produced is of a particle shape. The flux allows the compound of formula 3 of a particle shape to have a fine and uniform particle size. By the presence of the flux, the compound of formula 3 may have a uniform particles size of about 20 .mu.m or less. As used herein, the expression “uniform particles size of about 20 .mu.m or less” indicates that large particles of more than about 20 mu.m in size are not substantially produced.

The red phosphor prepared by the method of this embodiment includes the compound of formula 3 with a fine and uniform particle size and the flux. Even when the flux remains in the red phosphor thus prepared, the emission characteristics of the red phosphor are not adversely affected.

If a temperature for thermally treating the slurry is too low, the compound of formula 3 may not easily be crystallized. On the other hand, if it is too high, the compound of formula 3 may be molten, thereby lowering emission intensity. Furthermore, a produced red phosphor may have unwanted physical properties. In this regard, it is preferable that the temperature for thermally treating the slurry ranges from about 600 to about 1,400.degree. C.

The operation of thermally treating the slurry may be performed under an oxidizing atmosphere or a reducing atmosphere according to properties of raw materials.

Preferably, the operation of thermally treating the slurry is performed for 1 to 10 hours. If the thermal treatment duration is less than one hour, sufficient crystals may not be obtained. On the other hand, if it exceeds 10 hours, coarse powders may be produced, thereby decreasing emission intensity.

The method of this embodiment may further include washing. The washing is to remove the flux from the red phosphor including the compound of formula 3 and the flux. In the operation of washing, a cleaning solution capable of dissolving the flux is used. The cleaning solution may be water. By the washing, the content of the flux in the red phosphor can be decreased. Since the emission characteristics of the red phosphor of the present invention are determined by the compound of formula 3, even when the flux is removed from the red phosphor, the emission characteristics of the red phosphor are not adversely affected.

The method of this embodiment may further include removing the volatile polar solvent from the slurry prior to the operation of thermally treating the slurry. For this, the slurry may be dried at about 40 to about 150.quadrature.

The present invention also provides a red light emitting diode (LED) comprising: a red phosphor comprising a compound of formula 1 above and a flux; and a 380-420 nm UV LED.

The present invention also provides a white light emitting diode (LED) comprising: a phosphor combination of a red phosphor comprising a compound of formula 1 above and a flux, a green phosphor and a blue phosphor; and a 380-420 nm UV LED.

The green phosphor may be (Ba.sub.1−xSr.sub.x)SiO.sub.4:Eu.sup.2+(0.ltoreq.x.ltoreq.1).

Also, the blue phosphor may be (Sr.sub.x(Mg,Ca).sub.1-x).sub.5PO.sub.4Cl:Eu.sup.2+(0.ltoreq.x.ltoreq.1).

Hereinafter, the present invention will be described more specifically by Examples. However, the following Examples are provided only for illustrations and thus the present invention is not limited to or by them.

### EXAMPLE 1

### Li.sub.1.2(MoO.sub.4).sub.2:Eu.sub.0.8Sm.sub.0.08+H.sub.3BO.sub.3(1 wt %)

Li.sub.2CO.sub.3, MoO.sub.3, Eu.sub.2O.sub.3, Sm.sub.2O.sub.3, H.sub.3BO.sub.3, and acetone were well mixed using a mortar to make slurry. The slurry was placed in an alumina reaction vessel and thermally treated under an air atmosphere with gradually increasing temperature from 600.degree. C. to 1,000.degree. C. for three hours to produce powders. The powders thus produced were washed with distilled water and dried at room temperature to give a red phosphor according to the present invention.

### EXAMPLE 2

### Li.sub.1.2(MoO.sub.4).sub.2:Eu.sub.0.8Sm.sub.0.08+H.sub.3BO.sub.3(3 wt %)

A red phosphor according to the present invention was prepared in the same manner as in Example 1 except that 3 wt % of H.sub.3BO.sub.3 was used.

### EXAMPLE 3

### Li.sub.1.2(MoO.sub.4).sub.2:Eu.sub.0.8Sm.sub.0.08+H.sub.3BO.sub.3(5 wt %)

A red phosphor according to the present invention was prepared in the same manner as in Example 1 except that 5 wt % of H.sub.3BO.sub.3 was used.

### EXAMPLE 4

### Li.sub.1.2(MoO.sub.4).sub.2:Eu.sub.0.8Sm.sub.0.08+H.sub.3BO.sub.3(10 wt %)

A red phosphor according to the present invention was prepared in the same manner as in Example 1 except that 10 wt % of H.sub.3BO.sub.3 was used.

### EXAMPLE 5

### Li.sub.1.2(MoO.sub.4).sub.2:Eu.sub.0.8Sm.sub.0.08+H.sub.3BO.sub.3(15 wt %)

A red phosphor according to the present invention was prepared in the same manner as in Example 1 except that 15 wt % of H.sub.3BO.sub.3 was used.

### COMPARATIVE EXAMPLE 1

### Li.sub.1.2(MoO.sub.4).sub.2:Eu.sub.0.8Sm.sub.0.08

In this Comparative Example, a red phosphor was prepared without using a flux. Li.sub.2CO.sub.3, MoO.sub.3, Eu.sub.2O.sub.3, Sm.sub.2O.sub.3, and acetone were well mixed using a mortar to make slurry. The slurry was placed in an alumina reaction vessel and thermally treated under an air atmosphere with gradually increasing temperature from 600.degree. C. to 1,000.degree. C. for three hours to produce powders. The powders thus produced were washed with distilled water and dried at room temperature to give the red phosphor.

### COMPARATIVE EXAMPLE 2

### K.sub.5(WO.sub.4).sub.6.25:Eu.sub.2.5Sm.sub.0.08

In this Comparative Example, a red phosphor was prepared without using a flux. K.sub.2CO.sub.3, WO.sub.3, Eu.sub.2O.sub.3, Sm.sub.2O.sub.3, and acetone were well mixed using a mortar to make slurry. The slurry was placed in an alumina reaction vessel and thermally treated under a 900.degree. C. air atmosphere for three hours to produce powders. The powders thus produced were washed with distilled water and dried at room temperature to give the red phosphor.

<Flux Addition Effect—Particle Size of Red Phosphor>

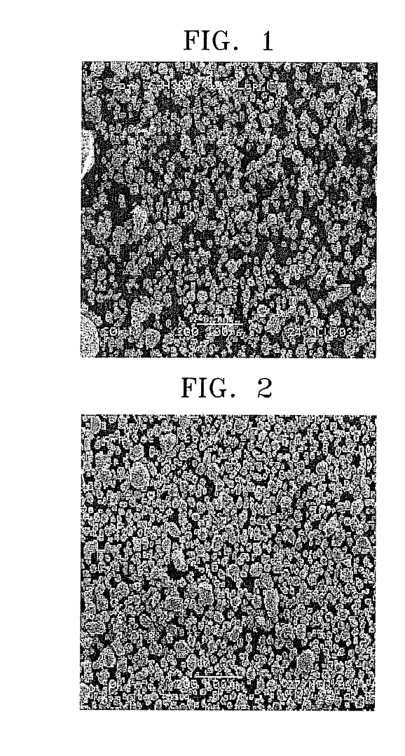

A scanning electron microscopic (SEM) analysis for the red phosphors prepared in Examples 1-5 was performed. A SEM image for the red phosphor of Example 4 is shown in FIG. 1. A SEM analysis for the red phosphors prepared in Comparative Examples 1-2 was performed. A SEM image for the red phosphor of Comparative Example 1 is shown in FIG. 2.

In comparison with the SEM images of FIGS. 1 and 2, the red phosphor of Example 4 had a fine and uniform particle size, relative to that of Comparative Example 1. In FIG. 2, a large number of phosphor particles with a particle size of more than about 20 .mu.m were observed. However, in FIG. 1, phosphor particles with a particle size of about 3 to about 20 .mu.m were observed and no phosphor particles with a particle size of more than about 20 .mu.m were observed. In this respect, it can be seen that the addition of the flux allowed the red phosphor of Example 4 to have a fine and uniform particle size.

From this result, it can be seen that when a compound of formula 1 forms particles, the growth of the particles is controlled by a flux disposed at the interfaces between the particles.

<Emission Characteristics of Red Phosphor of the Present Invention>

Emission characteristics of red phosphors were evaluated by i) efficient excitation light source determination and ii) main emission light wavelength determination. For the efficient excitation light source determination, the emission intensity of light emitted from a red phosphor according to the wavelength of excitation light incident in the red phosphor was measured using a spectrophotometer. For the main emission light wavelength determination, the relative intensity of light emitted from a red phosphor excited by long wavelength UV of 384 nm in wavelength was measured with respect to an emission wavelength.

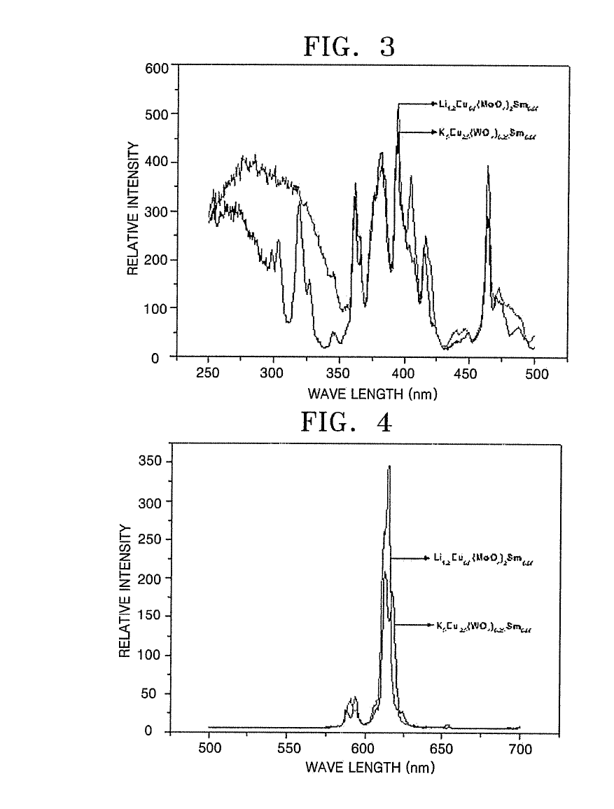

Analysis results for “efficient excitation light source determination” for the red phosphors of Examples 4 and 9 are shown in FIG. 3. Referring to FIG. 3, the red phosphors of Examples 4 and 9 were efficiently excited by long wavelength UV of about 394 nm in wavelength and emitted strong visible light.

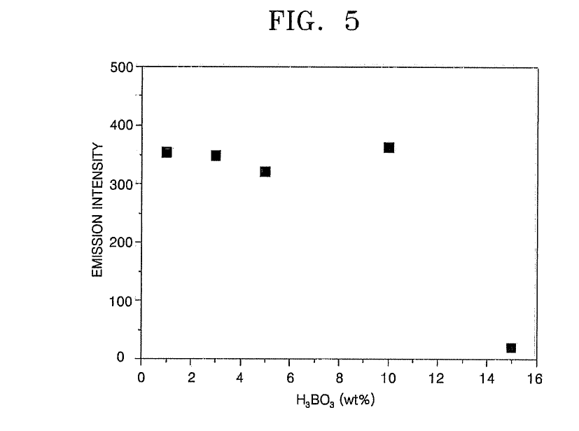

Analysis results for “main emission light wavelength determination” for the red phosphors of Examples 4 and 9 are shown in FIG. 4. Referring to FIG. 4, the red phosphors of Examples 4 and 9 excited by long wavelength UV of about 394 nm in wavelength mainly emitted visible light with a wavelength of about 630 nm. In this respect, it can be seen that a red phosphor of the present invention is efficiently excited by long wavelength UV and emits strong red visible light.

Little difference in emission characteristics between the presence and absence of a flux was observed. In this respect, it can be seen that the addition of the flux does not adversely affect emission characteristics.

FIG. 5 is a graph that illustrates a change in emission intensity of a red phosphor with respect to an addition amount of a flux. The emission intensity of FIG. 5 is the intensity of visible light emitted from a red phosphor excited by long wavelength UV of 394 nm in wavelength. FIG. 5 shows emission intensities of the red phosphors of Examples 1-5. As shown in FIG. 5, the emission intensity of the red phosphor of Example 5, in which 15 wt % (based on the total weight of the mixture) of the flux was used, was remarkably low, relative to that of the red phosphors of Examples 1-4. In this respect, it can be seen that an addition amount of a flux is preferably less than about 15 wt %.

A red phosphor of the present invention is excellent in emission efficiency by long wavelength UV excitation source and has a fine and uniform particle size. A method of preparing a red phosphor of the present invention can easily produce a red phosphor which is excellent in emission efficiency by long wavelength UV excitation source and has a fine and uniform particle size.

What is claimed is:

1. A method of preparing a red phosphor, comprising: dispersing a lithium-containing compound, an A-containing compound, an europium-containing compound, a samarium-containing compound, and a flux in a volatile polar solvent to obtain a slurry; and thermally heating the slurry at about 600 to about 1,400.degree. C., wherein A is Mo or W.

2. The method of claim 1, wherein the flux is a boron-containing compound.

3. The method of claim 2, wherein the boron-containing compound is B.sub.2O.sub.3, H.sub.3BO.sub.3, or a mixture thereof.

4. The method of claim 1, further comprising washing the red phosphor with a cleaning solution capable of dissolving the flux, after the operation of thermally treating the slurry.

5. A method of preparing a red phosphor, comprising: dispersing a lithium-containing compound, an M-containing compound, an A-containing compound, an europium-containing compound, a samarium-containing compound, and a flux in a volatile polar solvent to obtain a slurry; and thermally heating the slurry at about 600 to about 1,400.degree. C., wherein M is K, Mg, Na, Ca, Sr, or Ba, and A is Mo or W.

6. A method of preparing a red phosphor, comprising: dispersing an M-containing compound, an A-containing compound, an europium-containing compound, a samarium-containing compound, and a flux in a volatile polar solvent to obtain a slurry; and thermally heating the slurry at about 600 to about 1,400.degree. C., wherein M is K, Mg, Na, Ca, Sr, or Ba, and A is Mo or W.
